(19) United States
(12) Patent Application Publication
(10) Pub. No.: US 2019/0197699 A1
(43) Pub. Date: Jun. 27, 2019

(54) OPTICAL FLOW ACCURACY CALCULATING DEVICE AND OPTICAL FLOW ACCURACY CALCULATING METHOD

(71) Applicant: MITSUBISHI ELECTRIC CORPORATION, Tokyo (JP)

(72) Inventors: Hideaki MAEHARA, Tokyo (JP); Momoyo HINO, Tokyo (JP)

(73) Assignee: MITSUBISHI ELECTRIC CORPORATION, Tokyo (JP)

(21) Appl. No.: 16/322,229

(22) PCT Filed: Sep. 16, 2016
(86) PCT No.: PCT/JP2016/077487

§ 371 Date: Jan. 31, 2019

(51) Int. Cl. G06T 7/20; G06T 7/70; G06T 1/60

(52) U.S. Cl. CPC G06T 7/20; G06T 1/60; G06T 7/70

(57) ABSTRACT

A return point acquiring unit refers to both a first optical flow from an image to an image, and a second optical flow from the image to the image, to acquire the coordinates of a return point which is an end point of the second optical flow. An accuracy calculating unit calculates the accuracy of the optical flows on the basis of the difference between the coordinates of a start point of the first optical flow and the coordinates of the return point acquired by the return point acquiring unit.

### TECHNICAL FIELD

The present invention relates to an optical flow accuracy calculating device for and an optical flow accuracy calculating method of calculating the accuracy of optical flows between two images.

### BACKGROUND ART

For example, in Patent Literature 1, a method of determining whether or not a pixel-to-pixel mapping between two images is correct is described. An optical flow is a set of vectors showing to which point of one of two images a point of the other one of the two images corresponds.

Therefore, the pixel-to-pixel mapping described in Patent Literature 1 is equivalent to an optical flow.

### CITATION LIST

### Patent Literature

Patent Literature 1: Japanese Unexamined Patent Application Publication No. 2001-124519

### SUMMARY OF INVENTION

### Technical Problem

However, the method described in Patent Literature 1 is one of determining whether or not a pixel-to-pixel mapping between two images is correct, but is not one of explicitly showing the accuracy of optical flows.

Therefore, degree of the accuracy or the error of optical flows cannot be acquired as quantitative data.

The present invention is made in order to solve the above-mentioned problem, and it is therefore an object of the present invention to provide an optical flow accuracy calculating device and an optical flow accuracy calculating method capable of calculating the accuracy of optical flows.

### Solution to Problem

An optical flow accuracy calculating device according to the present invention includes a return point acquiring unit and an accuracy calculating unit. The return point acquiring unit refers to both a first optical flow from one of two images to another one of the two images, and a second optical flow returning from an end point of the first optical flow to a start point of the first optical flow, to acquire the coordinates of a return point which is an end point of the second optical flow. The accuracy calculating unit calculates the accuracy of the optical flows between the two images on the basis of the difference between the coordinates of the start point of the first optical flow and the coordinates of the return point acquired by the return point acquiring unit.

### Advantageous Effects of Invention

According to the present invention, the difference between the coordinates of a start point of the first optical flow from one of the two images to the other image and the coordinates of a return point which is an end point of the second optical flow returning from the other image to the one of the images is calculated. As a result, the accuracy of the optical flows can be calculated on the basis of this difference.

### BRIEF DESCRIPTION OF DRAWINGS

FIG. 1 is a block diagram showing an example of the configuration of an optical flow accuracy calculating device according to Embodiment 1 of the present invention;

FIG. 2A is a block diagram showing an example of a hardware configuration for implementing the function of the optical flow accuracy calculating device;

FIG. 2B is a block diagram showing an example of a hardware configuration for executing software to implement the function of the optical flow accuracy calculating device;

FIG. 3 is a view showing an outline of optical flows between an image A and an image B, the optical flows having no error;

FIG. 4 is a view showing an outline of optical flows between the images A and B, the optical flows having an error;

FIG. 5 is a view showing an outline of optical flows between the images A and B, the optical flows having a further error;

FIG. 6 is a flowchart showing the operation of the optical flow accuracy calculating device according to Embodiment 1 of the present invention;

FIG. 7 is a view showing a concrete example of the images A and B;

FIG. 8 is a view showing a result of the calculation of the first optical flow from the image A of FIG. 7 to the image B of FIG. 7; and

FIG. 9 is a view showing a result of cross-referencing the optical flows between the images A and B.

### DESCRIPTION OF EMBODIMENTS

Hereafter, in order to explain the present invention in greater detail, embodiments of the present invention will be described with reference to the accompanying drawings.

### Embodiment 1

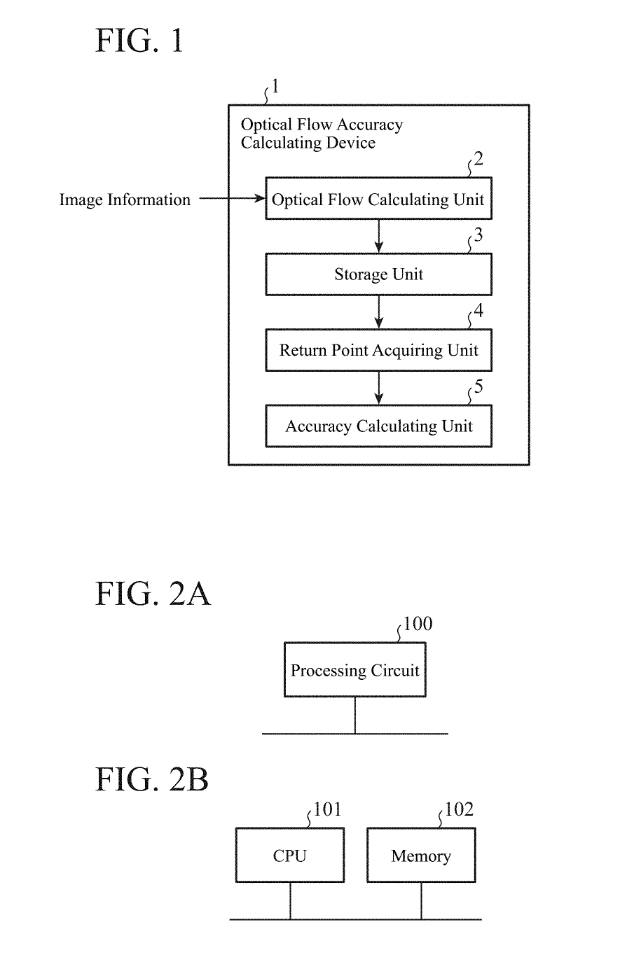

FIG. 1 is a block diagram showing an example of the configuration of an optical flow accuracy calculating device 1 according to Embodiment 1 of the present invention. The optical flow accuracy calculating device 1 calculates the accuracy of optical flows between two images, and includes an optical flow calculating unit 2, a storage unit 3, a return point acquiring unit 4, and an accuracy calculating unit 5.

Hereafter, it is assumed that the optical flow accuracy calculating device 1 calculates an accuracy P of optical flows between an image A and an image B.

As the images A and B, for example, two continuous time series frame images in video data are provided.

The optical flow calculating unit 2 calculates both a first optical flow from the image A to the image B, and a second optical flow from the image B to the image A.

The first optical flow is information showing a vector extending from a start point on the image A to an end point on the image B, the end point corresponding to the start point.

Further, the second optical flow is information showing a vector extending from the end point of the first optical flow on the image B to an end point on the image A, this end point corresponding to the end point of the first optical flow, i.e., extending from the end point of the first optical flow toward the start point of the first optical flow.

Therefore, when there is no error in the optical flows between the images A and B, the end point of the second optical flow matches the start point of the first optical flow on the image A.

The storage unit 3 stores the optical flows calculated by the optical flow calculating unit 2. The storage unit 3 can be disposed on a storage area of a storage device which is included in the optical flow accuracy calculating device 1, or can be disposed on a storage area of an external device with which the optical flow accuracy calculating device 1 can exchange data.

The return point acquiring unit 4 refers to the first and second optical flows stored in the storage unit 3, to acquire the coordinates of a return point which is the end point of the second optical flow. Hereafter, referring to the first and second optical flows between the images A and B is referred to as the cross reference of the optical flows.

The cross reference of the optical flows is performed in accordance with the following procedure.

First, by referring to the first optical flow while paying attention to the coordinates (x, y) of a point p on the image A, the coordinates (x′, y′) of a point p′ on the image B which is the end point of the first optical flow starting from the point p are acquired. Then, by referring to the second optical flow starting from the point p′ and extending toward the point p on the image A, the coordinates (x″, y″) of a point p″ on the image A which is the end point of the second optical flow are acquired as the return point.

As mentioned above, when there is no error in the optical flows between the images A and B, the coordinates (x, y) of the point p obviously match the coordinates (x″, y″) of the point p.

The accuracy calculating unit 5 calculates the accuracy P of the optical flows between the images A and B on the basis of the difference between the coordinates (x, y) of the point p and the coordinates (x″, y″) of the point p″, on the image A.

For example, the return point acquiring unit 4 sets each of multiple pixels on the image A as a point p, and acquires the coordinates (x″, y″) of the return point corresponding to each of these points.

The accuracy calculating unit 5 calculates the root mean square error (RMSE) between the coordinates of the multiple points p and the coordinates of the multiple return points corresponding to these points p, and calculates, as the accuracy P of the optical flows, the value which is the result of further dividing the RMSE calculated thereby by the square root of 2.

Although in FIG. 1, the configuration in which the optical flow accuracy calculating device 1 includes the optical flow calculating unit 2 and the storage unit 3 is shown, these functional components can be included in a device different from the optical flow accuracy calculating device 1.

More specifically, because the optical flow accuracy calculating device 1 according to Embodiment 1 can calculate the accuracy P by using the existing optical flow information, the optical flow accuracy calculating device should just include at least the return point acquiring unit 4 and the accuracy calculating unit 5.

FIG. 2A is a block diagram showing an example of a hardware configuration for implementing the function of the optical flow accuracy calculating device 1. FIG. 2B is a block diagram showing an example of a hardware configuration for executing software to implement the function of the optical flow accuracy calculating device 1.

Each of the functions of the optical flow calculating unit 2, the storage unit 3, the return point acquiring unit 4, and the accuracy calculating unit 5 of the optical flow accuracy calculating device 1 shown in FIG. 1 is implemented by a processing circuit.

More specifically, the optical flow accuracy calculating device 1 includes a processing circuit for performing these functions successively.

The processing circuit can be hardware for exclusive use, or can be a CPU (Central Processing Unit) or a GPU (Graphic Processing Unit) that reads and executes a program stored in a memory.

In a case in which the processing circuit is a processing circuit 100 shown in FIG. 2A which is hardware for exclusive use, the processing circuit 100 is, for example, a single circuit, a composite circuit, a programmable processor, a parallel programmable processor, an ASIC (Application Specific Integrated Circuit), an FPGA (Field-Programmable Gate Array), or a combination of these circuits.

Further, the functions of the optical flow calculating unit 2, the storage unit 3, the return point acquiring unit 4, and the accuracy calculating unit 5 can be implemented by respective processing circuits, or the functions of the units can be implemented collectively by a single processing circuit.

In a case in which the above-mentioned processing circuit is a CPU 101 as shown in FIG. 2B, the functions of the optical flow calculating unit 2, the storage unit 3, the return point acquiring unit 4, and the accuracy calculating unit 5 are implemented by software, firmware, or a combination of software and firmware.

Software and firmware are described as programs and the programs are stored in a memory 102. The CPU 101 implements the function of each of the units by reading and executing a program stored in the memory 102. More specifically, the memory 102 is included for storing a program which implements each of the functions as a result when the program is executed by the CPU 101.

Further, these programs cause a computer to perform procedures or methods which are used by the optical flow calculating unit 2, the storage unit 3, the return point acquiring unit 4, and the accuracy calculating unit 5.

Here, the memory is, for example, a non-volatile or volatile semiconductor memory, such as a RAM (Random Access Memory), a ROM, a flash memory, an EPROM (Erasable Programmable ROM), or an EEPROM (Electrically EPROM); a magnetic disk, a flexible disk, an optical disc, a compact disc, a mini disc, a DVD (Digital Versatile Disk), or the like.

A part of the functions of the optical flow calculating unit 2, the storage unit 3, the return point acquiring unit 4, and the accuracy calculating unit 5 can be implemented by hardware for exclusive use, and a rest of the functions can be implemented by software or firmware.

For example, the functions of the optical flow calculating unit 2, the storage unit 3, and the return point acquiring unit 4 are implemented by using the processing circuit 100 which is hardware for exclusive use, and the function of the accuracy calculating unit 5 is implemented by the CPU 101's execution of a program stored in the memory 102.

In this way, the above-mentioned processing circuit can implement the above-mentioned functions by using hardware, software, firmware, or a combination of hardware, software, and firmware.

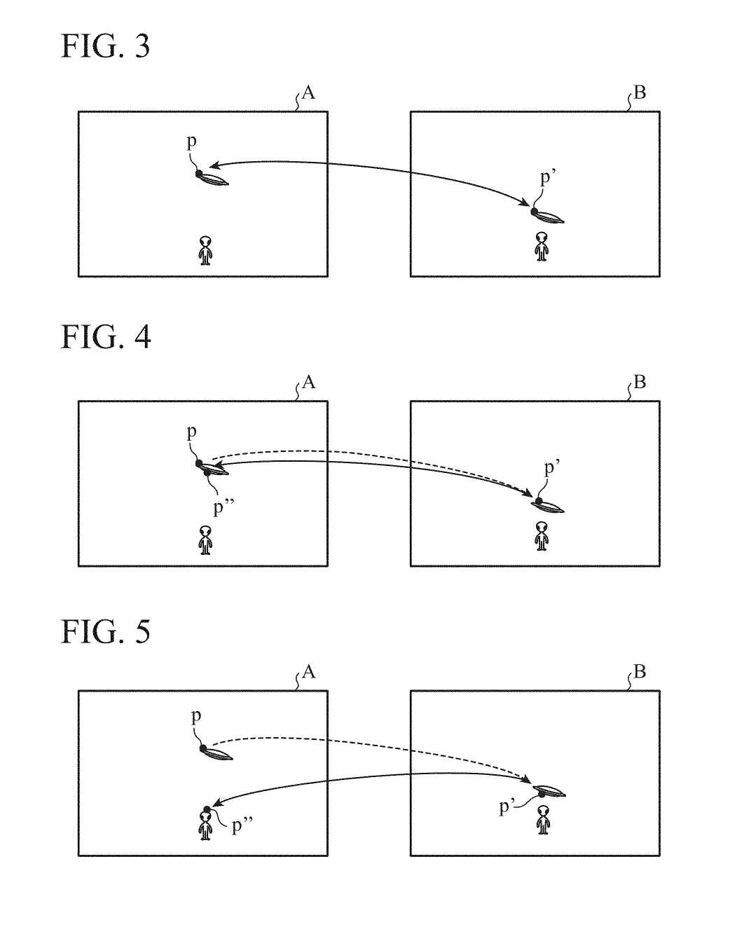

Next, the principle of the calculation of the accuracy P of the optical flows in Embodiment 1 will be explained using FIGS. 3 to 5.

FIG. 3 is a view showing an outline of the optical flows between an image A and an image B, the optical flows having no error. In FIG. 3, a dotted arrow denotes the first optical flow from the image A to the image B. Further, a solid arrow denotes the second optical flow from the image B to the image A. Here, there is no error in the first optical flow, and there is no error also in the second optical flow. Therefore, the coordinates (x″, y″) of a return point which is an end point of the second optical flow match the coordinates (x, y) of a point p which is a start point of the first optical flow on the image A. The point p′ is an end point of the first optical flow starting from the point p, and is a start point of the second optical flow. The coordinates of the point p′ are (x′, y′).

FIG. 4 is a view showing an outline of the optical flows between the images A and image B, the optical flows having an error. Here, at least one of the first and second optical flows has an error. By referring to the first optical flow starting from the coordinates (x, y) of the point p, the coordinates (x′, y′) of the point p′ on the image B which is an end point of the first optical flow can be acquired.

Further, by referring to the second optical flow starting from the coordinates (x′, y′) of the point p′, the coordinates (x″, y″) of the point p″ on the image A which is the end point of the second optical flow can be acquired.

Because at least one of the coordinates (x′, y′) of the point p′ and the coordinates (x″, y″) of the point p″, which are acquired here, differs from that in the case in which there is no error in the optical flows, the coordinates (x, y) of the point p and the coordinates (x″, y″) of the point p″ do not match each other, as shown in FIG. 4.

FIG. 5 is a view showing an outline of the optical flows between the images A and B, the optical flows having a further error. Here, at least one of the first and second optical flows has a larger error than that in the case shown in FIG. 4.

It can be considered that when the optical flows have a large error, the degree of mismatch between the coordinates (x, y) of the point p and the coordinates (x″, y″) of the point p″ is usually larger than that in the case in which the optical flows have a small error, as shown in FIG. 5.

Therefore, by assuming the coordinates (x, y) of a point p on the image A which is a start point of the first optical flow to be true values, each of multiple pixels on the image A is set as the point p. By calculating the RMSE between the coordinates (x″, y″) of the points p″ corresponding to the points pset in this way, and the coordinates (x, y) of the points p, a quantification of the accuracy P of the optical flows is possible.

In order to acquire the coordinates (x, y) of the point p and the coordinates (x″, y″) of the point p″, it is necessary to refer to the first and second optical flows, as mentioned above.

More specifically, in the acquisition of these coordinates, the optical flows are referred twice.

This process corresponds to the case of the number of trials n=2 in the random walk problem described in, for example, the following reference literature.

(Reference Literature) “Knowledge of random numbers” written by Kazumasa Wakimoto, Morikita Shuppan, August 1970

On the basis of the principle shown in the above-mentioned reference literature, the accuracy P of the optical flows between the images A and B can be calculated from the following equation (1).

P=RMSE/√2 (1)

Next, an operation will be explained.

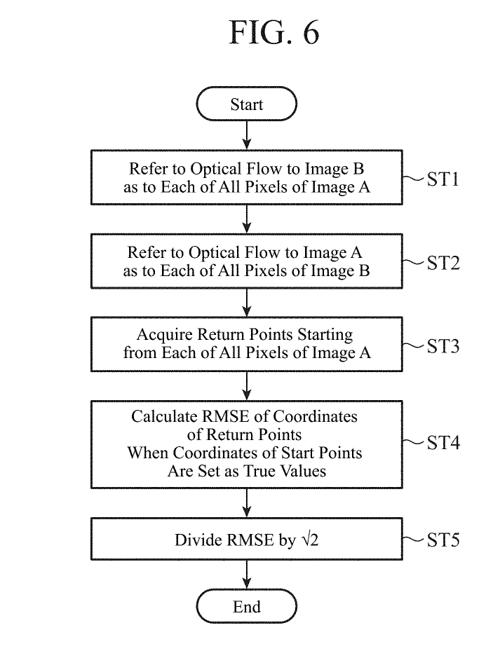

FIG. 6 is a flow chart showing the operation of the optical flow accuracy calculating device 1, and shows a series of processes of calculating the accuracy P of the optical flows between the image A and the image B.

First, the return point acquiring unit 4 refers to the first optical flow starting from the coordinates (x, y) of a point p on the image A, and stored in the storage unit 3 (step ST1). As a result, the return point acquiring unit 4 acquires the coordinates (x′, y′) of a point p′ on the image B which is an end point of the first optical flow. Here, all the pixels of the image A are set as points p, and the coordinates of the point p′ corresponding to these points p are acquired.

Next, the return point acquiring unit 4 refers to the second optical flow starting from the point p′ on the image B, and stored in the storage unit 3 (step ST2). As a result, the return point acquiring unit 4 acquires, as a return point, the coordinates (x″, y″) of a point p″ on the image A which is an end point of the second optical flow (step ST3).

Here, all the pixels of the image B are set as points p′, and the coordinates of the points p″ corresponding to these points p′ are acquired. More specifically, return points starting from all the pixels of the image A are acquired.

Next, the accuracy calculating unit 5 calculates the RMSE of the coordinates of the return points in a case in which the coordinates of the start points of the first optical flow are assumed to be true values (step ST4). More specifically, by assuming that the coordinates of the points p are true values, the RMSE of the coordinates of the return points with respect to these true values is calculated.

After that, the accuracy calculating unit 5 calculates, as the accuracy P of the optical flows between the images A and B, a value which is the result of dividing the RMSE by the square root of 2 (step ST5).

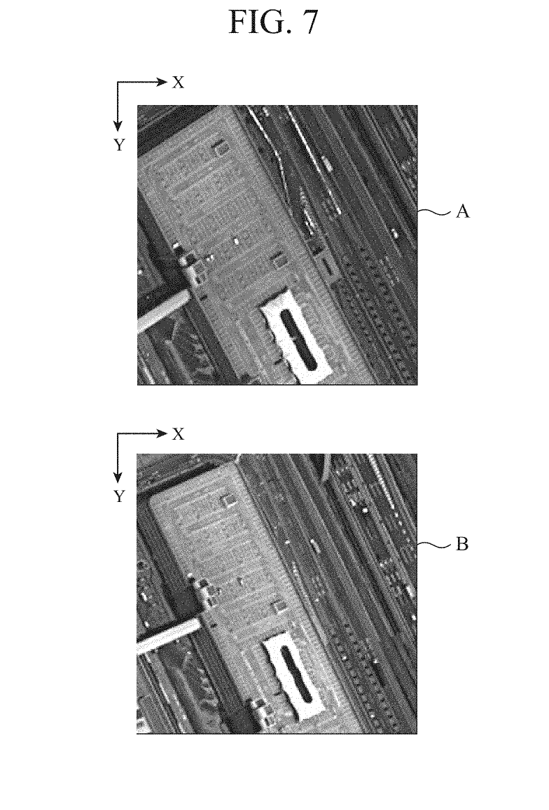

FIG. 7 is a view showing a concrete example of the images A and B. In FIG. 7, the images A and B are, for example, two continuous frame images of video data. By performing an arithmetic operation using an image correlation method on the images A and image B as input images, the optical flows between the images A and B can be calculated. The image correlation method is one of searching for the location of a pattern in an image after change, which is very similar to a pattern of the image before change, and is widely used in the industry.

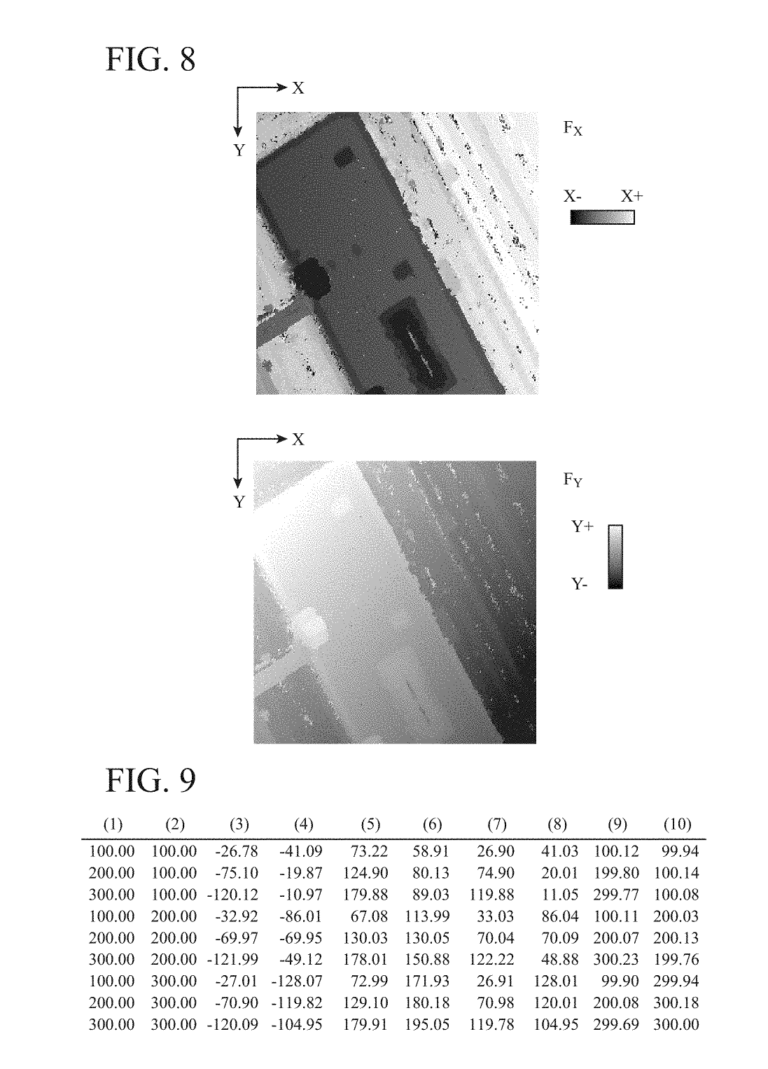

FIG. 8 is a view showing a result of the calculation of the first optical flow from the image A of FIG. 7 to the image B of FIG. 7. In FIG. 8, the first optical flow is calculated by using the image correlation method in which the images A and B are set as input images. Color encoding is performed on the optical flow, and the optical flow is displayed while being superimposed on the image A. For example, an upper view of FIG. 8 shows a result of performing color encoding on the magnitudes of the X direction components of the optical flow, and a lower view shows a result of performing color encoding on the magnitudes of the Y direction components of the optical flow.

This display process is an existing technique.

Further, FIG. 9 is a view showing a result of cross-referencing the optical flows between the images A and B. In FIG. 9, (1) shows coordinates (X) on the image A, and (2) shows coordinates (Y) on the image A. (3) shows the magnitudes of X direction components of the first optical flow from the image A to the image B, and (4) shows the magnitudes of Y direction components of the first optical flow. (5) shows coordinates (X) on the image B, and (6) shows coordinates (Y) on the image B. (7) shows the magnitudes of X direction components of the second optical flow from the image B to the image A, and (8) shows the magnitudes of Y direction components of the second optical flow. In addition, (9) shows coordinates (X) on the image A, and (10) shows coordinates (Y) on the image A.

In FIG. 9, as shown in (1) and (2), the cross reference of the optical flows is performed, starting from nine sets of coordinates (100.00, 100.00) to (300.00, 300.00) on the image A. Here, although the nine sets of coordinates on the image A are handled, for the sake of simplicity in an explanation presented below, all the pixels of the image A can be set as start points, like in the case of the processing explained using FIG. 6.

For example, when the coordinates (100.00, 100.00) are the coordinates (x, y) of a point p, the first optical flow is (−26.78, −41.09), as shown in (3) and (4). The return point acquiring unit 4 calculates the coordinates (73.22, 58.91) shown in (5) and (6) by referring to this first optical flow. This point is the coordinates (x′, y′) of a point p′ on the image B which is an end point of the first optical flow.

On the other hand, as shown in (7) and (8), the second optical flow starting from the coordinates (x′, y′) of the point p′ on the image B are (26.90, 41.03).

The return point acquiring unit 4 acquires the coordinates (100.12, 99.94) shown in (9) and (10) by referring to this second optical flow.

This point corresponds to the coordinates (x″, y″) of the point p″ on the image A which is an end point of the second optical flow, i.e., a return point.

As to the coordinates of each of the nine start points, the return point acquiring unit 4 acquires the coordinates of the corresponding return point in this way.

The accuracy calculating unit 5 assumes the coordinates of each of the nine start points to be true values and calculates the RMSE of the return points, so that BRfSE=0.22 is acquired.

Next, the accuracy calculating unit 5 divides the RMSE by the square root of 2 in accordance with the above-mentioned equation (1), so that the accuracy P=0.15 of the optical flows between the images A and B is acquired.

Therefore, the accuracy P of these optical flows can be quantified to be a quantitative value such as 0.15 pixels. For example, in a case in which there are several different algorithms for calculating optical flows, by using, as a reference, the accuracy P of the optical flows, it becomes possible to quantitatively make a comparison to determine how accurately and as to which target which algorithm can calculate the optical flows.

Although the example in which the value which is the result of dividing by the square root of 2 the RMSE between the coordinates of points p each of which is a start point of the first optical flow and the coordinates of points p″ each of which is a return point corresponding to the start point is defined as the accuracy P of the optical flows has been explained up to now, the embodiment is not limited to this example. For example, any value can be used as the accuracy P of the optical flows as long as the value can quantify the difference between the coordinates of the points p and the coordinates of the points p″.

More specifically, the optical flow accuracy calculating device 1 quantifies (digitizes) the accuracy P of the optical flows on the basis of the difference between the coordinates of the points p and the coordinates of the points p″.

As mentioned above, the optical flow accuracy calculating device 1 according to Embodiment 1 includes the return point acquiring unit 4 and the accuracy calculating unit 5. The accuracy calculating unit 5 can calculate the accuracy P of the optical flows on the basis of the difference between the coordinates of points p each of which is a start point of the first optical flow and the coordinates of points p″ each of which is an end point of the second optical flow returning from the image B to the image A.

The above-mentioned difference can be the RMSE between the coordinates of start points of the first optical flow and the coordinates of return points corresponding to these start points, and, in this case, a value which is the result of dividing the RNSE by the square root of 2 is the accuracy P.

While the present invention has been described in its preferred embodiment, it is to be understood that various changes can be made in an arbitrary component according to the embodiment, or an arbitrary component according to the embodiment can be omitted within the scope of the invention.

### INDUSTRIAL APPLICABILITY

Because the optical flow accuracy calculating device according to the present invention can calculate the accuracy of optical flows, the optical flow accuracy calculating device is suitable for, for example, an object detection device or the like that detects an object from image information.

### REFERENCE SIGNS LIST

1 optical flow accuracy calculating device, 2 optical flow calculating unit, 3 storage unit, 4 return point acquiring unit, 5 accuracy calculating unit, 100 processing circuit, 101 CPU, and 102 memory.

1. An optical flow accuracy calculating device comprising:
a processor; and
a memory storing instructions, upon executed by the processor, causing the processor to perform a process to:
refer to both a first optical flow from one of two images to another one of the two images, and a second optical flow returning from an end point of the first optical flow to a start point of the first optical flow, to acquire coordinates of a return point which is an end point of the second optical flow; and
calculate, as accuracy of the optical flows between the two images, a value which is a result of dividing by a square root of 2 a root mean square error between coordinates of the start point of the first optical flow and the coordinates of the return point acquired from the end point of the second optical flow.

2. (canceled)

3. An optical flow accuracy calculating method comprising:
referring to both a first optical flow from one of two images to another one of the two images, and a second optical flow returning from an end point of the first optical flow to a start point of the first optical flow, to acquire coordinates of a return point which is an end point of the second optical flow; and
calculating as accuracy of the optical flows between the two images, a value which is a result of dividing by a square root of 2 a root mean square error between coordinates of the start point of the first optical flow and the coordinates of the return point acquired from the end point of the second optical flow.
